(19) United States
(12) Patent Application Publication
(10) Pub. No.: US 2005/0043454 A1
(43) Pub. Date: Feb. 24, 2005

(54) Water-base composition and crosslinking agent for water-soluble polymers

(76) Inventors: Kuniyuki Ushida, Chiba (JP); Hiroshi Suzuki, Kanagawa (JP); Kenzo Ban, Chiba (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/496,973

(22) PCT Filed: Nov. 28, 2002
(86) PCT No.: PCT/JP02/12458

(30) Foreign Application Priority Data
Nov. 30, 2001 (JP) 2001-367001
Nov. 27, 2002 (JP) 2002-344197

(51) Int. Cl. C08K 3/10; C09K 3/00

(52) U.S. Cl. 524/241; 252/182.13; 524/413

(57) ABSTRACT

The present invention provides a crosslinking agent for a water-soluble polymer, which is stable and which provides the water-soluble polymer with improved water resistance and excellent characteristics. Further, the invention provides an aqueous composition suitable as a surface treating agent by which the characteristics of a substrate surface can be improved. The aqueous composition of the invention comprises a mixed aqueous solution containing a chelating agent having a pH of from 1 to 7 and a zirconium compound, and is useful as a surface treating agent, a crosslinking agent for a water-soluble polymer, etc. As the chelating agent, there may be listed amino carboxylic acid or its derivatives and, as the amino carboxylic acid, there may be listed monoamino monocarboxylic acid or monoamino dicarboxylic acid.

### TECHNICAL FIELD

The present invention relates to an aqueous composition, a crosslinking agent for a water-soluble polymer, a surface treating agent and a water-soluble polymer composition.

### BACKGROUND TECHNOLOGY

Conventionally, vinyl alcohol polymers (hereinafter referred to also as PVA and the like) are known to have improved properties such as excellent film forming properties, oil resistance, solvent resistance and strength, and they are used widely as surface treating agents for various types of binders, adhesives, ink jet type papers, etc.

However, because PVA and the like have water-soluble properties, they suffer from low resistance to water, particularly when they are dried at a low temperature, and various proposals have been made to overcome these drawbacks.

As a means for improving the water resistance by using crosslinking agents, there have been known to cross-link the PVA and the like with, for example, glyoxal, glutaraldehyde or dialdehyde starch, a water-soluble epoxy compound or a methylol compound.

However, it is necessary to heat the PVA and the like to a temperature of 100° C. or higher, preferably 120° C. or higher to make them fully water resistant by the above method. When the PVA and the like are made water resistant by a method of drying them under a low temperature, it has been known to carry out the method at a strongly acidic condition, such as pH 2 or below. But there arises a problem of poor viscosity stability of the aqueous solution of the PVA and the like.

It has also been known to use a titanium compound such as a titanium lactate (Japanese Unexamined Patent Publication No. 49-94768). But this method causes a problem of changing the PVA and the like to yellow.

Recently, water-soluble polymers such as highly ink absorptive polyvinyl alcohols, etc. have been used in the ink receiving layer for ink jet paper. For example, methods using zirconyl hydroxy chloride or zirconyl acetate have been proposed (Japanese Unexamined Patent Publication No. 11-78220, for example) to improve the water resistance and the strength of the film obtained as an ink receptor layer.

However, there is a restriction in the usable pH area when zirconyl hydroxy chloride or zirconyl acetate is used. Particularly, when the pH applied is in the area from a weak acidic to weak basic environment, a precipitate means that the obtained product cannot be used.

As has been mentioned above, there are problems in using the conventional crosslinking agent for making the water-soluble polymer water resistant. Therefore, the present inventors have made an extensive study to find a crosslinking agent for a water-soluble polymer which provides the water-soluble polymer with excellent water resistance and improved properties, and succeeded in completing the invention. The completed invention relates also to an aqueous composition suitable as a surface treating agent by which the characteristics of a substrate surface can be improved.

### DISCLOSURE OF THE INVENTION

The aqueous composition of the invention comprises a mixed aqueous solution containing a chelating agent having a pH from 1 to 7 and a zirconium compound. The chelating agent is preferably an amino carboxylic acid or its derivative. The amino carboxylic acid is preferably a monoamino monocarboxylic acid or monoamino dicarboxylic acid. The zirconium compound is water-soluble and is selected from inorganic salts, organic salts and complex salts. Concretely, the zirconium compound is preferably selected from a group consisting of zirconyl hydroxy chloride, oxy zirconium chloride, zirconyl ammonium carbonate, zirconyl sulfate, and zirconyl nitrate. The molar ratio of the zirconium compound to the chelating agent is normally from 1:0.1 to 1:4, and preferably 1:0.2 to 1:2.5. The aqueous composition of the invention further contains preferably a pH modifier. The pH of the mixed aqueous solution is preferably from 1 to 10.

The crosslinking agent for the water-soluble polymer of the invention comprises a mixed aqueous solution containing a chelating agent having a pH from 1 to 7 and a zirconium compound. The chelating agent is preferably an amino carboxylic acid or its derivative. The amino carboxylic acid is preferably a monoamino monocarboxylic acid or monoamino dicarboxylic acid. The zirconium compound is water-soluble and is selected from inorganic salts, organic salts and complex salts. Concretely, the zirconium compound is preferably selected from a group consisting of zirconyl hydroxy chloride, oxy zirconium chloride, zirconyl ammonium carbonate, zirconyl sulfate, and zirconyl nitrate. The molar ratio of the zirconium compound to the chelating agent is normally from 1:0.1 to 1:4, and preferably 1:0.2 to 1:2.5. The crosslinking agent for the water-soluble polymer of the invention further contains preferably a pH modifier. The pH of the mixed aqueous solution is preferably from 1 to 10. The water-soluble polymer preferably contains hydroxyl groups in its molecule.

The surface treating agent of the invention comprises a mixed aqueous solution containing a chelating agent having a pH from 1 to 7 and a zirconium compound. The chelating agent is preferably an amino carboxylic acid or its derivative. The amino carboxylic acid is preferably a monoamino monocarboxylic acid or monoamino dicarboxylic acid. The zirconium compound is water-soluble and is selected from inorganic salts, organic salts and complex salts. Concretely, the zirconium compound is preferably selected from a group consisting of zirconyl hydroxy chloride, oxy zirconium chloride, zirconyl ammonium carbonate, zirconyl sulfate, and zirconyl nitrate. The molar ratio of the zirconium compound to the chelating agent is normally from 1:0.1 to 1:4, and preferably 1:0.2 to 1:2.5. The surface treating agent of the invention further contains preferably a pH modifier. The pH of the mixed aqueous solution is preferably from 1 to 10.

The water-soluble polymer composition of the invention is produced by mixing a water-soluble polymer with the above water-soluble composition, preferably in an amount of 100 parts by weight (dried amount) of the water-soluble polymer with 1 to 50 parts by weight (dried amount) of the aqueous composition. Further, the water-soluble polymer composition of the invention is produced by mixing the crosslinking agent for the above water-soluble polymer with an water-soluble composition, preferably in an amount of 100 parts by weight (dried amount) of the water-soluble polymer with 1 to 50 parts by weight (dried amount) of the crosslinking agent, and more preferably in an amount of 100 parts by weight (dried amount) of the water-soluble polymer with 5 to 30 parts by weight (dried amount) of the crosslinking agent.

The method of cross-linking the water-soluble polymer comprises cross-linking the above water-soluble polymer composition. The cross-linking process is carried out preferably at a temperature from a room temperature to 150° C.

The substrate coated with the cross-linked water-soluble polymer is obtained by coating the water-soluble polymer to a substrate, followed by cross-linking the polymer. The polymer is applied in a thickness of from 0.1 μm to 1 mm, normally.

The cross-linked, water-soluble polymer film or sheet of the invention is obtained by preparing the water-soluble polymer to a film or sheet, and by cross-linking the polymer. The polymer film or sheet is controlled to have a thickness of from 5 μm to 5 mm, normally.

The adhesive composition of the invention is obtained by mixing the aqueous composition with the water-soluble polymer.

The coating composition of the invention is obtained by mixing the aqueous composition with the water-soluble polymer.

### BEST MODE FOR CARRYING OUT THE INVENTION

The invention will be explained in detail.

The chelating agent used for the aqueous composition of the invention has a pH of from 1 to 7 and suppresses precipitate production. A preferred chelating agent is an amino carboxylic acid or its derivative.

When the aqueous composition of the invention is used as a crosslinking agent for a water-soluble polymer, the polymer, provided with water resistant properties, is commonly used in a area from a weak acidic to weak basic environment. In the area, the amino carboxylic acid or its derivative properly stabilizes zirconium atoms in the aqueous solution and can suppress the production of precipitate. The amino carboxylic acid or its derivative preferably has an amino acid with an amino group (—NH₂) and a carboxyl group (—COOH) in its molecule, or an imino group such as proline or hydroxyproline which has an imino group (—NH) in place of the amino group. The amino acid is normally α-amino acid, but β, γ, or δ-amino acid may be used. The amino acid should have a pH of from 1 to 7. A preferred amino acid is monoamino monocarboxylic acid or monoamino dicarboxylic acid. The derivative of the amino carboxylic acid is one in which one or two hydrogen atoms of the amino group are replaced, a complex with a chelate by the nitrogen of the amino group and the oxygen of the carboxyl group of the amino acid, etc. The derivative should have a pH of from 1 to 7.

Examples of the preferred amino carboxylic acid or derivative include dihydroxymethyl glycine, dihydroxyethylglycine, dihydroxypropyl glycine, dihydorxybutyl glycine, glycine, aranine, valine, leucine, isoleucine, serine, histidine, threonine, glycidylglycine, 1-aminocyclopropane carboxylic acid, 1-aminocyclohexane carboxylic acid and 2-aminocyclohexane hydrocarboxylic acid. They may be used either singly or in the form of a mixture.

The zirconium compound usable for the invention is water-soluble and can be used in a form of an inorganic salt, an organic salt, or a complex. Examples of the zirconium compound include zirconyl hydroxy chloride, oxy zirconium chloride, zirconyl ammonium carbonate, zirconyl sulfate, zirconyl nitrate, zirconyl phosphate, zirconyl oxalate, zirconyl malate, zirconyl and lactate. They may be used either singly or in the form of a mixture of two or compounds. These zirconium compounds are suitably used because they can be easily handled. For example, the zirconyl hydroxy chloride is stable in the weak acidic to weak basic area.

The aqueous composition of the invention comprises a mixed aqueous solution obtained by properly mixing the chelating agent with the zirconium compound, and can be used for a surface treating agent, a crosslinking agent for a water-soluble polymer, etc.

The molar ratio of the zirconium compound to the chelating agent, for example, is 1:0.1 to 1:4, and preferably 1:0.2 to 1:2.5.

When the molar ratio of the chelating agent to the zirconium compound is less than 0.1, the resultant aqueous composition loses its stability in a neutral area while, when it is more than 4, the water resistant properties are greatly reduced. The crosslinking agent of the invention can be diluted with water, if necessary.

The mixed solution composing the crosslinking agent of the invention is maintained preferably at pH 1 to 10, and there occurs no precipitation.

The crosslinking agent of the invention may contain basic compounds, organic acid salts or the like, for regulating the pH value, or for other purposes.

Examples of the basic compounds include ammonia, sodium hydroxide, potassium hydroxide, amines such as triethylamine, tripropylamine, triethanol amine, diethanol amine, monoethanol amine, tripropanol amine, dipropanol amine, monopropanol amine, triisopropanol amine, diisopropanol amine, monoisopropanol amine, N,N-dimethylethanol amine, ethylene imine, pyrrolidine and piperidine, and polyethylene imine. They may be used either singly or in the form of a mixture.

Particularly preferred are alcohol amines such as triethanol amine, diethanol amine, monoethanol amine, tripropanol amine, dipropanol amine, monopropanol amine, triisopropanol amine, diisopropanol amine, monoisopropanol amine and N,N-dimethylethanol amine, ethylene imine, amines such as pyrrolidine and piperidine, and polyethylene imine.

Preferred organic acid salt is sodium lactate, etc.

When a basic compound is mixed with the crosslinking agent of the invention for regulating the pH value or for other purposes, the molar ratio of the zirconium compound to the basic compound is 1: less than 2, and preferably 1: less than 1. When the molar ratio of the basic compound is 2 or more, the water resistant properties of the resultant crosslinking agent are also greatly reduced.

When an organic acid salt is mixed with the crosslinking agent of the invention, the molar ratio of the zirconium compound to the organic acid salt is, just as in the case of the above basic compound, 1: less than 2, and preferably 1: less than 1.

The crosslinking agent of the present invention is used for cross-linking the water-soluble polymer which has preferably hydroxyl groups in its molecule. For example, the water-soluble polymer may be polyvinyl alcohol, carboxyl group-modified polyvinyl alcohol, sulfonic acid-modified polyvinyl alcohol, acetoacetyl group-modified polyvinyl alcohol, silyl group-modified polyvinyl alcohol, cellulose, etc. They may be used either singly or in the form of a mixture. The water-soluble polymer used may be one other than those exemplified above and it is preferably a vinyl alcohol polymer having a saponification rate of 1 to 100 mol %, preferably 10 to 100 mol %.

A copolymer of an ethylenic unsaturated monomer copolymerizable with the vinyl alcohol may also be used.

Examples of the ethylenic unsaturated monomer include ethylene, propylene, isobutylene, α-octene, α-dodecene, α-octadodecene, acrylic acid, methacrylic acid, crotonic acid, phthalic acid, maleic acid (anhydride), itaconic acid (anhydride), acrylonitrile, methacrylonitrile, acrylamide, methacrylamide, trimethyl-(3-acrylamide-3-dimethylpropyl)-ammonium chloride, acrylamide-2-methylpropane sulfonic acid and its sodium salt, ethyl vinyl ether, butyl vinyl ether, N-vinyl pyrrolidone, vinyl chloride, vinyl bromide, vinyl fluoride, vinylidene chloride, tetrafluoroethylene, sodium vinyl sulfonate and sodium allylsulfonate. They may be used either singly or in the form of a mixture.

A water-soluble polymer composition is obtained by mixing the crosslinking agent for a water-soluble polymer with the above mentioned water-soluble polymer. 1 to 50 parts by weight (dried amount), preferably 5 to 30 parts by weight, of the crosslinking agent is mixed with 100 parts by weight (dried amount) of the water-soluble polymer.

When the water-soluble polymer composition contains the crosslinking agent in a dried amount of less than 1 part by weight, its water resistance providing effect is reduced and the composition is not practically used. On the other hand, a composition containing the crosslinking agent in a dried amount of more than 50 parts by weight is not economical.

The water-soluble polymer composition can form a coated substrate when it is used to coat a substrate, for a surface treatment. The substrate coated may be paper, resin applied paper, transparent or opaque thermoplastic resin film or plate such as film or plate of polyethylene terephthalate, polypropylene, polyethylene, polyvinyl chloride, polymethyl methacrylate, polycarbonate, etc., or metallic plate or film of iron, copper, aluminum or stainless steel. There is no limitation to the shape of the substrate. For example, the substrate may have a two dimensional shape as printed paper or film, columnar or three-dimensional shape, or string or thread like shape. Also, there is no limitation to the purpose of the surface treatment or coating of a substrate. That is, the substrate may be coated with the water-soluble polymer composition for the protection of the surface, improvement in water resistance, sizing, treatment for ensuring proper printing, adhesion, etc. The substrate may be coated by a conventional coating process including impregnating the substrate. For example, the substrate is coated normally by a method selected from a curtaining method, extrusion method, air knife method, roll coating method, rod bar coating method, etc. The substrate may be coated after the mixed aqueous solution is mixed with the water-soluble polymer of the invention. Otherwise, the substrate may be coated on its surface first with either the mixed aqueous solution or the water-soluble polymer and then with the other one, i.e., the water-soluble polymer or the mixed aqueous solution.

The mixed aqueous solution of the invention reacts with the hydroxyl group or amino group of a water-soluble polymer such as PVA, polyacrylic acid and polyvinyl amine to form a cross-linked structure and, thus, the water-soluble polymer is provided with water resistant properties. Also, the zirconium compound contained in the mixed aqueous solution of the invention may react or coordinate selectively with pigments, dyes, etc. contained in ink or the like and form an adduct. Therefore, when the water-soluble composition comprising the mixed aqueous solution of the invention is used as a surface treating agent in combination with the water-soluble polymer for the treatment of the surface of paper and the like, ink can be prevented from bleeding or running and the color tone can be stabilized.

For a surface treatment of a substrate, the coating solution used is prepared by adding 1 to 3 parts of an aqueous composition (crosslinking agent) to 100 parts of 4.5% aqueous solution of polyvinyl alcohol. Further, other substances may be contained, for example, inorganic particles such as silica, calcium carbonate, titanium oxide and mica, organic particles such as polystyrene, acryl polymer, urethane polymer, etc., surfactants, ultraviolet absorbers, antioxidants, fungicides, etc. The coating solution may be applied in a thickness of normally 2 μm to 1 mm, preferably 10 to 200 μm.

The coated water-soluble polymer can be treated to have a cross-linking structure and can be provided with water resistance, by a conventional method. There is no limitation to a particular cross-linking process. Normally, the process is carried out by drying the polymer (removal of moisture) at a temperature from a room temperature to 150° C.

The obtained coated substrate is used as it is depending on applications, or it is further processed to produce a final article, as has been so previously.

According to the invention, the water-soluble polymer composition can be extended to form a film or sheet-like product without a substrate. Because the polymer can be cross-linked during the time it is extended, a cross-linked (that is, water-resistant) water-soluble polymer film or sheet can be easily obtained. In this instance, the film or sheet normally has a thickness from 5 μm to 5 mm.

The obtained film or sheet also is used as it is depending on applications, or it is further processed to produce a final article, as has been so previously.

The aqueous composition of the invention has been explained to be used as crosslinking agent for a water-soluble polymer. But the aqueous composition of the invention is itself useful as a surface treatment agent. In this instance, the mixed aqueous solution may be substantially same as the crosslinking agent, but may be selected from various types, depending on applications.

The invention is explained by reference to working examples. It should naturally be understood that the invention is not limited by the examples. Wherever parts are mentioned in the examples, they are meant as parts by weight.

Preparation of water-soluble polymer: A water-soluble polymer was dissolved in water to prepare a 5% aqueous solution.

(1) Film-Forming Process

A predetermined part in a dried amount of a crosslinking agent was added to, and was mixed with 100 parts of a 5% water-soluble polymer solution to prepare a uniform solution. Subsequently, about 5 g of the solution was taken in an aluminum cup and was dried at 40° C. for 16 hours to obtain a membrane.

(2) Evaluation Method

The evaluation was carried out by a following method, which is stricter than that used in practical conditions, for comparing test results of examples.

Measurement of the ratio of insoluble matter: The obtained membrane and about 100 ml of water were taken into a 100 ml beaker and were boiled for one hour. Then, the insoluble matter was filtered off using filter paper. Subsequently, the filtrate was dried at 105° C. for two hours and the mass was measured.

The ratio of the insoluble matter (%)=[(C−B)/A]×100

where

A=the mass (g) of the membrane prior to making the test,

B=the mass (g) of the filter paper, and

C=the mass (g) of the filter paper plus the insoluble matter.

Determination of coloring: The outer appearance of the obtained membrane was checked. Transparent membrane was marked as ◯ while yellow tinted membrane was marked X. Stability test at the neutral area: 10 g of the crosslinking agent was made to a pH 7 to 8 with an ammonia water, and the outer appearance was checked. A transparent solution was marked as ◯, while the solution that changed to a gel or that produced precipitate was marked X.

### EXAMPLES 1 to 13 AND COMPARATIVE EXAMPLES 1 to 4

Table 1 shows the mixing ratio of the crosslinking agent and the result of the test, for each of Examples 1 to 13, and Table 2 shows the mixing ratio of the crosslinking agent and the result of the test, for each of Comparative Examples 1 to 4.

TABLE 1

| | | Example No. | | | | | | | | | | | | |
|---|---|---|---|---|---|---|---|---|---|---|---|---|---|---|
| Ingredients | | 1 | 2 | 3 | 4 | 5 | 6 | 7 | 8 | 9 | 10 | 11 | 12 | 13 |
| Zirconium | ZIRCOSOL ZC-2 | 35.4 | 35.4 | 35.4 | 35.4 | 35.4 | 35.4 | 35.4 | 35.4 | 35.4 | 35.4 | 35.4 | 35.4 | 35.4 |
| compound | | | | | | | | | | | | | | |
| Chelating | Dihydroxyethyl | 8.2 | 12.3 | — | — | — | — | — | 8.2 | 8.2 | 8.2 | 8.2 | — | — |
| agent | glycine | | | | | | | | | | | | | |
| | Glycine | — | — | 7.5 | 11.3 | — | — | — | — | — | — | — | 7.5 | 7.5 |
| | Serine | — | — | — | — | 10.5 | — | — | — | — | — | — | — | — |
| | Threonine | — | — | — | — | — | 11.9 | — | — | — | — | — | — | — |
| | Glycidylglycine | — | — | — | — | — | — | 13.2 | — | — | — | — | — | — |
| Diluent | Water | 78 | 94 | 75 | 90 | 87 | 92 | 97 | 108 | 124 | 83 | 83 | 76 | 86 |
| Basic | Triethanol amine | — | — | — | — | — | — | — | 7.5 | 11.3 | — | — | — | — |
| compound | 28% ammonia water | — | — | — | — | — | — | — | — | — | 1.5 | — | — | — |
| | KOH | — | — | — | — | — | — | — | — | — | — | 1.4 | — | — |
| | Aqueous solution | — | — | — | — | — | — | — | — | — | — | — | 4.0 | — |
| | polyethylene of | | | | | | | | | | | | | |
| | 30% polyethyle | | | | | | | | | | | | | |
| | imine | | | | | | | | | | | | | |
| Organic | Aqueous solution | — | — | — | — | — | — | — | — | — | — | — | — | 5.6 |
| acid salt | of 60% sodium | | | | | | | | | | | | | |
| | lactate | | | | | | | | | | | | | |
| Zr comp.:chelating agent | | 1:0.5 | 1:0.75 | 1:1 | 1:1.5 | 1:1 | 1:1 | 1:1 | 1:0.5 | 1:0.5 | 1:0.5 | 1:0.5 | 1:1 | 1:1 |
| (molar ratio) | | | | | | | | | | | | | | |
| Zr comp.:basic compound | | 1:0 | 1:0 | 1:0 | 1:0 | 1:0 | 1:0 | 1:0 | 1:0.5 | 1:0.75 | 1:0.25 | 1:0.25 | 1:0.001 | — |
| (molar ratio) | | | | | | | | | | | | | | |
| Zr comp.:organic acid salt | | 1:0 | 1:0 | 1:0 | 1:0 | 1:0 | 1:0 | 1:0 | 1:0 | 1:0 | 1:0 | 1:0 | 1:0 | 1:0.3 |
| (molar ratio) | | | | | | | | | | | | | | |
| Dried amount (%) | | 20 | 20 | 20 | 20 | 20 | 20 | 20 | 20 | 20 | 20 | 20 | 20 | 20 |
| Evaluation | Stability at | ∘ | ∘ | ∘ | ∘ | ∘ | ∘ | ∘ | ∘ | ∘ | ∘ | ∘ | ∘ | ∘ |
| | neutral area | | | | | | | | | | | | | |

Note
ZIRCOSOL ZC-2: Aqueous solution of zirconyl hydroxy chloride
ZrO₂: 35% (produced by New Tex KK)
Polyethylene imine: EPOMIN P-1030 (Mn = 8,000˜13,000) (produced by Nippon Shokubai KK)
Sodium lactate: 60% fermented sodium lactate (produced by PURAC Japan)

TABLE 2

| | | Comparative examples | | | |
|---|---|---|---|---|---|
| Ingredients | | 1 | 2 | 3 | 4 |
| Zirconium | ZIRCOSOL ZC-2 | 35.4 | 35.4 | — | — |
| compound | | | | | |
| Chelating | Acetylacetone | 5 | — | — | — |
| agent | | | | | |
| Diluent | Water | 65 | 45 | 18 | 75 |
| Other water | ORGATIX | — | — | 50 | — |
| resistance | ZB-115 | | | | |
| providing | ORGATIX | — | — | — | 50 |
| agents | TC-310 | | | | |
| Zr compound:chelating | | 1:0.5 | — | — | — |
| agent (molar ratio) | | | | | |
| Dried amount (%) | | 20 | 20 | 20 | 20 |
| Evaluation | Stability in | ∘ | x | x | ∘ |
| | neutral area | | | | |

Note
ZIRCOSOL ZC-2: Aqueous solution of basic zirconyl chloride ZrO₂: 35% (produced by New Tex KK)
ORGATIX ZB-115: Aqueous solution of zirconyl acetate ZrO₂ 15% (produced by Matsumoto Chemical Industry Co., Ltd.)
ORGATIX TC-310: Aqueous solution of titanium propyl alcohol lactate- Ti 8% (produced by Matsumoto Chemical Industry Co., Ltd.)

### EXAMPLES 14 to 31 AND COMPARATIVE EXAMPLES 5 to 8

Table 3 shows the mixing ratio of a 5% water soluble polymer solution with a crosslinking agent to obtain a water-soluble polymer composition and the result of the test, for each of Examples 14 to 31, and Table 4 shows the mixing ratio of a 5% water soluble polymer solution with a crosslinking agent and the result of the test, for each of Comparative Examples 5 to 8.

TABLE 3

| | | Example | | | | | | | | |
|---|---|---|---|---|---|---|---|---|---|---|
| Ingredients | | 14 | 15 | 16 | 17 | 18 | 19 | 20 | 21 | 22 |
| 5% aqueous | GOHSENOL | 100 | 100 | 100 | — | — | — | 100 | 100 | 100 |
| polymer | N-300 | | | | | | | | | |
| solution | PVA-217 | — | — | — | 100 | — | — | — | — | — |
| | PVA-505 | — | — | — | — | 100 | — | — | — | — |
| | GOHSENOL | — | — | — | — | — | 100 | — | — | — |
| | T-350 | | | | | | | | | |
| Water | Example 1 | 1.25 | 3.75 | 7.5 | 3.75 | 3.75 | 3.75 | — | — | — |
| resistance | Example 2 | — | — | — | — | — | — | 3.75 | — | — |
| providing | Example 3 | — | — | — | — | — | — | — | 3.75 | — |
| composition | Example 4 | — | — | — | — | — | — | — | — | 3.75 |
| | Example 5 | — | — | — | — | — | — | — | — | — |
| | Example 6 | — | — | — | — | — | — | — | — | — |
| | Example 7 | — | — | — | — | — | — | — | — | — |
| | Example 8 | — | — | — | — | — | — | — | — | — |
| | Example 9 | — | — | — | — | — | — | — | — | — |
| | Example 10 | — | — | — | — | — | — | — | — | — |
| | Example 11 | — | — | — | — | — | — | — | — | — |
| | Example 12 | — | — | — | — | — | — | — | — | — |
| | Example 13 | — | — | — | — | — | — | — | — | — |
| Water-soluble | | 100:5 | 100:15 | 100:30 | 100:15 | 100:15 | 100:15 | 100:15 | 100:15 | 100:15 |
| polymer:water | | | | | | | | | | |
| resistance providing | | | | | | | | | | |
| composition (weight | | | | | | | | | | |
| ratio of dried | | | | | | | | | | |
| amount) | | | | | | | | | | |
| Evaluation | Coloring | ∘ | ∘ | ∘ | ∘ | ∘ | ∘ | ∘ | ∘ | ∘ |
| | Ratio(%) of | 10 | 16 | 20 | 15 | 15 | 16 | 13 | 15 | 13 |
| | insoluble | | | | | | | | | |
| | matter | | | | | | | | | |
| | | Example | | | | | | | | |
| Ingredients | | 23 | 24 | 25 | 26 | 27 | 28 | 29 | 30 | 31 |
| 5% aqueous | GOHSENOL | 100 | 100 | 100 | 100 | 100 | 100 | 100 | 100 | 100 |
| polymer | N-300 | | | | | | | | | |
| solution | PVA-217 | — | — | — | — | — | — | — | — | — |
| | PVA-505 | — | — | — | — | — | — | — | — | — |
| | GOHSENOL | — | — | — | — | — | — | — | — | — |
| | T-350 | | | | | | | | | |
| Water | Example 1 | — | — | — | — | — | — | — | — | — |
| resistance | Example 2 | — | — | — | — | — | — | — | — | — |
| providing | Example 3 | — | — | — | — | — | — | — | — | — |
| composition | Example 4 | — | — | — | — | — | — | — | — | — |
| | Example 5 | 3.75 | — | — | — | — | — | — | — | — |
| | Example 6 | — | 3.75 | — | — | — | — | — | — | — |
| | Example 7 | — | — | 3.75 | — | — | — | — | — | — |
| | Example 8 | — | — | — | 3.75 | — | — | — | — | — |
| | Example 9 | — | — | — | — | 3.75 | — | — | — | — |
| | Example 10 | — | — | — | — | — | 3.75 | — | — | — |
| | Example 11 | — | — | — | — | — | — | 3.75 | — | — |
| | Example 12 | — | — | — | — | — | — | — | 3.75 | — |
| | Example 13 | — | — | — | — | — | — | — | — | 3.75 |
| Water-soluble | | 100:15 | 100:15 | 100:15 | 100:15 | 100:15 | 100:15 | 100:15 | 100:15 | 100:15 |
| polymer:water | | | | | | | | | | |
| resistance | | | | | | | | | | |
| providing composition | | | | | | | | | | |
| (weight ratio of dried | | | | | | | | | | |
| amount) | | | | | | | | | | |
| Evaluation | Coloring | ∘ | ∘ | ∘ | ∘ | ∘ | ∘ | ∘ | ∘ | ∘ |
| | Ratio(%) of | 14 | 18 | 18 | 14 | 10 | 17 | 11 | 19 | 18 |
| | insoluble | | | | | | | | | |
| | matter | | | | | | | | | |

NOTE
GOHSENOL N-300: Polyvinyl alcohol having a saponification rate of 98˜99 mol % (Produced by Nippon Gohsei Kagaku Kogyo KK)
PVA-217: Polyvinyl alcohol having a saponification rate of 87˜89 mol % (Produced by Kuraray KK)
PVA-505: Polyvinyl alcohol having a saponification rate of 72.5˜74.5 mol % (Produced by Kuraray KK)
GOHSENOL T-350: Carboxyl-modified polyvinyl alcohol having a saponification rate of 93˜95 mol % (Produced by Nippon Gohsei Kagaku Kogyo KK)

TABLE 4

| | | Comparative Examples | | | |
|---|---|---|---|---|---|
| Ingredients | | 5 | 6 | 7 | 8 |
| 5% water | GOHSENOL | 100 | 100 | 100 | 100 |
| soluble | N-300 | | | | |
| polymer | | | | | |
| solution | | | | | |
| Water | Comparative | 3.75 | — | — | — |
| resistance | example 1 | | | | |
| providing | Comparative | — | 3.75 | — | — |
| compo- | Example 2 | | | | |
| sition | Comparative | — | — | 3.75 | — |
| | Example 3 | | | | |
| | Comparative | — | — | — | 3.75 |
| | Example 4 | | | | |
| Water soluble | | 100:15 | 100:15 | 100:15 | 100:15 |
| polymer:Water | | | | | |
| resistance providing | | | | | |
| composition | | | | | |
| (weight ratio of | | | | | |
| dried amount) | | | | | |
| Evaluation | Coloring | x | ∘ | ∘ | x |
| | Ratio(%) of | 15 | 30 | 10 | 25 |
| | Insoluble | | | | |
| | matter | | | | |

Note
GOHSENOL N-300: Polyvinyl alcohol having a saponification rate of 98˜99 mol % (Produced by Nippon Gohsei Kagaku Kogyo KK)

### EXAMPLE 32 AND COMPARATIVE EXAMPLE 9

Filter paper (produced by Advantec Toyo KK, No. 5A) was impregnated for five minutes in the mixed solution, prepared in Example 1, of zirconium compound/chelating agent with PVA. The filter paper, thus surface treated, was dried for 20 minutes at 60° C. (Example 32).

For comparison purposes, filter paper was impregnated just as above in a 5% aqueous PVA solution containing no zirconium compound/chelating agent, and was dried in a same way as above (Comparative Example 9).

Ink (Ink Tank BCI-M Magenta, produced by Canon KK) was adhered by a glass capillary to the obtained filter paper and was air-dried for a night and day at a room temperature.

To evaluate the ink bleeding, the filter paper to which ink was adhered was impregnated in water for one minute and was drawn up to observe the surface condition of the paper. It was found that a much smaller amount of ink was bled from the filter paper of Example 28 than that bled from the filter paper of Comparative Example 9.

When the aqueous composition of the invention is added to a water soluble polymer to be used as a crosslinking agent for the water soluble polymer, for example, it provides the water soluble polymer with the technical merits as follows:
(1) high water resistance;
(2) hard to be colored; and
(3) highly stable in the area from acidic to weakly basic range.

### INDUSTRIAL APPLICABILITY

The aqueous composition of the invention is useful as a surface treatment agent, a crosslinking agent for a water-soluble polymer, etc.

1. An aqueous composition comprising a mixed aqueous solution containing a chelating agent having a pH of from 1 to 7 and a zirconium compound.

2. An aqueous composition according to claim 1, wherein the chelating agent is an amino carboxylic acid or its derivative.

3. An aqueous composition according to claim 1, wherein the amino carboxylic acid is a monoamino monocarboxylic acid or monoamino dicarboxylic acid.

4. An aqueous composition according to claim 1, wherein the zirconium compound is water soluble.

5. An aqueous composition according to claim 1, wherein the zirconium compound is an inorganic salt, an organic salt or a complex.

6. An aqueous composition according to claim 1, wherein the zirconium compound is selected from a group consisting of zirconyl hydroxy chloride, oxy zirconium chloride, zirconyl ammonium carbonate, zirconyl sulfate, and zirconyl nitrate.

7. An aqueous composition according to claim 1, wherein the molar ratio of the zirconium compound to the chelating agent is from 1:0.1 to 1:4.

8. An aqueous composition according to claim 1, which further contains a pH modifier.

9. An aqueous composition according to claim 1, wherein the pH of the mixed aqueous solution is from 1 to 10.

10. A crosslinking agent for a water-soluble polymer, which comprises a mixed aqueous solution containing a chelating agent having a pH of from 1 to 7 and a zirconium compound.

11. A crosslinking agent for a water-soluble polymer according to claim 10, wherein the chelating agent is an amino carboxylic acid or its derivative.

12. A crosslinking agent for a water-soluble polymer according to claim 10, wherein the amino carboxylic acid is a monoamino monocarboxylic acid or monoamino dicarboxylic acid.

13. A crosslinking agent for a water-soluble polymer according to claim 10, wherein the zirconium compound is water soluble.

14. A crosslinking agent for a water-soluble polymer according to claim 10, wherein the zirconium compound is an inorganic salt, an organic salt or a complex.

15. A crosslinking agent for a water-soluble polymer according to claim 10, wherein the zirconium compound is selected from a group consisting of zirconyl hydroxy chloride, oxy zirconium chloride, zirconyl ammonium carbonate, zirconyl sulfate, and zirconyl nitrate.

16. A crosslinking agent for a water-soluble polymer according to claim 10, wherein the molar ratio of the zirconium compound to the chelating agent is from 1:0.1 to 1:4.

17. A crosslinking agent for a water-soluble polymer according to claim 10, which further contains a pH modifier.

18. A crosslinking agent for a water-soluble polymer according to claim 10, wherein the pH of the mixed aqueous solution is from 1 to 10.

19. A crosslinking agent for a water-soluble polymer according to claim 10, wherein the water-soluble polymer has hydroxyl groups in its molecule.

20. A surface treating agent comprising a mixed aqueous solution containing a chelating agent having a pH of from 1 to 7 and a zirconium compound.

21. A water-soluble polymer composition obtained by mixing the aqueous composition according to claim 1 with a water-soluble polymer.

22. A water-soluble polymer composition obtained by mixing the crosslinking agent for a water-soluble polymer according to claim 11 with the water-soluble polymer.

23. A water-soluble polymer composition according to claim 22, which is obtained by mixing 100 parts by weight (dried amount) of the water-soluble polymer with from 1 to 50 parts by weight (dried amount) of the crosslinking agent.

24. A method of cross-linking a water-soluble polymer comprising cross-linking the water-soluble polymer composition according to claim 22.

25. A substrate coated with a cross-linked water-soluble polymer obtained by applying the water-soluble polymer composition according to claim 22 to a substrate.

26. A cross-linked water-soluble polymer film or sheet obtained by forming the water-soluble polymer composition according to claim 23 to a film or sheet and by cross-linking the film or sheet.

27. An adhesive composition obtained by mixing a water-soluble polymer with the aqueous composition according to claim 1.

28. A coating composition obtained by mixing a water-soluble polymer with the aqueous composition according to claim 1.
